(19) United States
(12) Patent Application Publication
(10) Pub. No.: US 2026/0316996 A1
(43) Pub. Date: Oct. 15, 2026

(54) DRUM PALLET, FASTENING COMPONENT, TRANSPORT SYSTEM, AND USAGE METHOD

(71) Applicant: STV CO., LTD., Noda-City, Chiba-Pref (JP)

(72) Inventors: Masato KOMURA, Chiba-Pref (JP); Yuki IWAMOTO, Chiba-Pref (JP)

(73) Assignee: STV CO., LTD., Noda-City, Chiba-Pref (JP)

(21) Appl. No.: 19/111,093

(22) PCT Filed: Sep. 23, 2022
(86) PCT No.: PCT/JP2022/035553

§ 371 Date: Mar. 12, 2025

(30) Foreign Application Priority Data
Sep. 13, 2022 (JP) 2022-144950

(51) Int. Cl. B65D 71/00; B65D 19/44

(52) U.S. Cl. CPC B65D 71/0096; B65D 19/44; B65D 2519/00815; B65D 2519/0098; B65D 2571/00055; B65D 2571/00086

(57) ABSTRACT

A pallet includes a base board, and a leg that provides a clearance from an installation surface on a bottom surface side of the base board. The base board has a three-leaf pattern in a top view.

### TECHNICAL FIELD

The disclosure relates to a drum pallet, a fastening component, a transport system, and a usage method therefor. The disclosure relates to reuse, recycle, and the like.

### BACKGROUND ART

Drums are generally cylindrical containers mainly made of metal with a volume of 18 L or more and 400 L or less. Drums are ordinarily roughly classified into three types, that is, 200-liter drums, small and medium drums, and pail drums. Commonly used 200-liter drums have an outside diameter of 585 mm and a height of 890 mm (see, for example, JIS Z 1601). Such drums are generally placed on plastic pallets, wooden pallets, and the like and transported (see, for example, Patent Document 1).

In recent years, the three R's of Reduce, Reuse, and Recycle have been emphasized from the viewpoint of SDGs (Sustainable Development Goals). Steel drums can be reused. For plastic pallets, wooden pallets, and the like, on which drums are placed, the return and collection of pallets can be systematized among business operators in continuous business relationships, so pallets made for the purpose of repeated use (reusable pallets) are sometimes used; however, similar systems are difficult to be developed among business operators not in continuous business relationships, long-distance shipping, and the like, and one-way pallets are often used due to cost issues related to return and collection. One-way pallets often cannot be reused due to standards and quality issues and are mostly disposed of as waste at locations where goods are unpacked (such as logistics facilities and business places to which the goods are delivered) after being carried in. For this reason, disposal of pallets becomes an issue.

Conventionally used pallets, such as plastic pallets and wooden pallets, have a low-profile rectangular shape with gaps into which forks can be inserted. Such pallets can be easily assembled and manufactured at a low cost, so such pallets are preferable. However, it is not a good appearance with a cylindrical shape like drums. On the other hand, drums placed on a rectangular pallet are placed side by side so as to match the rectangular shape (see, for example, Patent Document 2). In this state, the drums on the pallets are loaded in trucks, trailers, containers, and the like, having rectangular (or rectangular parallelepiped) internal volumes and transported. At this time, rectangular pallets easily match the rectangular internal volume and also presumably excel in packing efficiency; however, drums cannot always be sufficiently loaded. In addition, for rectangular plastic pallets, wooden pallets, and the like, there can be restrictions on the fork insertion direction, that is, a length direction or a width direction.

Drums generally have rims called chimes that protrude from the bottom head and the top head, and have a smaller contact area than a surface on which each drum is put. Therefore, drums easily slip on hard installation surfaces. It is advantageous in easy of sideways movement, but, when drums are transported in a state of being placed on plastic pallets or wooden pallets, the drums need to be secured by other components to surfaces on which the drums are put (see, for example, Patent Document 1 or 3).

Incidentally, marine containers used for marine transportation and the like are defined by international standards (ISO standards) according to function and shape. The most widely distributed container is a 20-feet container or a 40-feet container and can have, for example, internal dimensions of 5,867 mm length×2,352 mm width×2,385 mm height. Therefore, when drums are arranged in the width direction, it is quite difficult in practice to arrange four drums, and, actually, only three drums can be arranged.

A reusable pallet device, a reusable pallet reuse system, and the like, have been suggested so far (see, for example, Patent Document 4 or 5).

### CITATION LIST

### Patent Document

Patent Document 1: Japanese Unexamined Patent Application Publication No. 10-265055 (JP 10-265055 A)
Patent Document 2: Japanese Unexamined Patent Application Publication No. 2001-130571 (JP 2001-130571 A)
Patent Document 3: Japanese Unexamined Patent Application Publication No. 2010-132330 (JP 2010-132330 A)
Patent Document 4: Japanese Unexamined Patent Application Publication No. 2004-075185 (JP 2004-075185 A)
Patent Document 5: Japanese Unexamined Patent Application Publication No. 2006-248745 (JP 2006-248745 A).

### SUMMARY OF THE INVENTION

### Technical Problem

However, in the case of drum pallets, it is not always preferable to uniformly reuse or recycle all the components. Components that need strength and components suitable for recycling are presumably mixed. It is also preferable to increase the packing efficiency of drums. It is also preferable to study further appropriate drum pallets and drum pallet loading methods for containers standardized in the world and used. It may be preferable to prevent a side slip of drums on surfaces on which the drums are placed.

### Solution to Problem

In view of the above-described challenges, according to an embodiment of the present application, it is possible to distinguish between parts suitable for reuse and parts suitable for disposal, increase the durability of the reusable parts, make the disposal parts from materials with low environmental load, and modify the shape and structure to make it easier to reuse and recycle parts. Modifications of materials and structures to improve durability can be made to the parts suitable for reuse. On the other hand, modifications of materials and structures to more easily disposable ones can be made to the parts suitable for disposal. Furthermore, it is possible to provide a transport system and a transport method to reduce the environmental load resulting from conducting logistics using these.

Specifically, the following devices and methods are provided.

A drum pallet capable of mounting a plurality of drums in an upright position includes at least three legs spaced at a predetermined clearance from a surface on which the pallet is put, a base board on which the legs are disposed at predetermined positions, and support pads provided on the base board, each of the support pads being configured to support at least part of a weight of a corresponding one of the drums,
the support pad can contact a bottom surface of a corresponding one of the drums, other than an outer peripheral edge. The support pads are provided on the base board such that, for the drums supported by the support pads, two of the drums, arranged side by side, are close to each other such that a positional relationship between the two drums can be restrained, and another one of the drums is allowed to be closely placed in a recess defined by the side-by-side two drums so that the another one drum can be restrained, and
each of the at least three legs is capable of supporting a main weight of the side-by-side two drums and the another one drum.
(1) A drum pallet capable of mounting a plurality of drums each placed upright includes:
at least three legs spaced at a predetermined clearance from a surface on which the pallet is put;
a base board on which the legs are disposed at predetermined positions; and
support pads provided on the base board, each of the support pads being configured to support at least part of a weight of a corresponding one of the drums, wherein
the support pad can come into contact with a bottom surface of a corresponding one of the drums, other than an outer peripheral edge,
the support pads are provided on the base board such that, for the drums supported by the support pads,
two of the drums, arranged side by side, are close to each other so that a positional relationship between the two drums can be restrained, and
another one of the drums is allowed to be closely placed in a recess defined by the side-by-side two drums so that the another one drum can be restrained,
each of the at least three legs is capable of supporting a main weight of the side-by-side two drums and the another one drum,
the base board and the support pads are made of a recyclable material, and
the legs are separable from the base board and reusable.

Drums may be ordinarily put in an upright position with a circular bottom surface or top surface facing or in contact with a drum placement surface in a substantially right cylindrical shape or put in a horizontal position with a curved surface that is a side surface of the substantially right cylindrical shape faced or in contact with the drum placement surface. The predetermined clearance may be a clearance with which insertion components (for example, forks and the like) of forklifts or the like can be inserted. The predetermined 15 positions may include positions as will be described later.

Here, the recyclable material may include, for example, paper, such as corrugated fiberboard. The paper is defined as “the one manufactured by agglutinating fibers of plant or others. In a broad sense, the paper includes synthetic paper that is manufactured using a synthetic polymer as a raw material and also includes paper blended with a fibrous inorganic material”. For example, the paper may include “the one made by dispersing fibers in water, separating residue in a thin and flat form with a strainer, and dehydrating and drying the residue”. Here, the term “recycling” may mean to regenerate and reuse those that are no longer needed or obtained collaterally as resources. For example, the recycling May include making recycled paper from raw materials including paper wastes. In a broader sense, the recyclable material may include the ones that are relatively easy to dispose of. The recyclable material may be made from paper. The term “reuse” may mean reuse, that is, to use repeatedly. The legs are preferably reusable. The legs are preferably reusable. The legs are preferably made of, for example, durable materials. The legs are made of, for example, resin like polypropylene. The resin may be any one of natural resin and synthetic resin. The legs may also be made of wood, metal, or inorganic compounds. Furthermore, the legs may be made of a composite material including any one of these materials.

The load of the drums mounted on the above-described drum pallet is mainly supported by the legs. Therefore, the base board does not necessarily need to support the load in a cantilever manner. In a load bearing system provided by the plurality of legs, the plurality of legs are disposed and configured as a whole so that the load based on the weight of all the drums can be stably born and the drums do not tip over. For example, at least one leg placed under the support pad may be disposed below or directly below the center of gravity of the drum above the leg. For example, the same number of legs as the number of drums may be provided, and each of the legs may be disposed below or directly below the center of gravity of a corresponding one of the drums. In addition, another leg may be provided below the combined center of gravity of all the drums. The base board does not need to bear a load in a cantilever manner but is preferably capable of withstanding tension (in the plane of the board) or compression (in the plane of the board) to a certain degree. If the drum sways due to vibration or the like, the position of the center of gravity may shift. Since drums are mainly used to store liquid or fluid, it is expected that so-called bias in weight (on the bottom surface or the like) is small. However, sway due to vibration or the like can occur. Optimization of the preferred number, preferred arrangement, and the like, of the legs, including these dynamic variations, is desired.

At least three legs are needed to stably support a mounted object. As the number of the legs increases, the stability is generally considered to increase. However, it is necessary to ensure insertion space and insertion passage for forks, so the number of legs is preferably not too many. The spacing between the forks may be selected as needed. It is not necessary to insert the forks in one direction, unlike a rectangular pallet. The forks may be allowed to be inserted at multiple angles in a wide range.
(2) In any one of the above-described drum pallets, the base board is a plate-shaped board connecting the at least three legs.
(3) In any one of the above-described drum pallets, the base board has a collective shape of three circles of substantially equal diameters, the circles being substantially tangential to each other in a top view.

The base board and the support pads may be made of a recyclable material, and the legs may be separable from the base board and reusable.
(4) In any one of the above-described drum pallets, at least one of the legs is disposed at a part of the base board, on which the support pad is provided.
(5) In any one of the above-described drum pallets, the leg includes a combined leg component.
(6) In any one of the above-described drum pallets, in the collective shape of three circles, each of the legs is disposed at a position outside a center of any one of the circles along a line passing through the center and a center of gravity of a triangle formed by connecting the centers of the three circles.

The triangle may be a two-dimensional imaginary one and may mean a shape that can be simply drawn. The center of gravity may mean a place that corresponds to the position of the center of gravity generally referred to in the two-dimensional triangle. The one circle may mean at least one circle of the above-described three circles.
(7) A drum pallet system includes:
any one of the above-described drum pallets; and
a fastening component capable of mutually restraining a plurality of drums mounted.

The above-described fastening component may include a fixing lid and/or a stopper. The fastening component may include a fixing lid and/or a stopper, and a threaded rod. The fastening component may further include a stuffing nut and a locking part. The fastening component may directly or indirectly contact at least part of a top surface of the mounted drum to hold the drum.
(8) Any one of the above-described drum pallet systems further includes a drum pallet capable of mounting one or two drums.
(9) A container storing a plurality of drums mounted on any one of the above-described drum pallets.
(10) A transport method for drums includes storing a plurality of drums in a container with any one of the above-described drum pallets.
(11) In any one of the above-described transport methods for drums, the drums mounted on the drum pallet are stored in the container in a state where one of the drums is closely placed in a recess defined by other adjacent two of the drums.
(12) A fastening component used for any one of the above-described drum pallets includes:
a hub;
arms extending radially in three directions from the hub; and
hooks engageable with outer peripheral edges of drums.
(13) A transport method includes: using any one of the above-described drum pallets; and
transporting drums mounted on the drum pallet in a state where one of the drums is closely placed in a recess defined by other adjacent two of the drums.
(14) In any of the above-described transport methods, the drums mounted on the drum pallet are loaded into a vehicle.
(15) A reuse and recycle method includes: in a pallet using any one of the above-described drum pallets, making the base board and the support pads from a recyclable material; separating the legs from the base board such that the legs are reusable; recycling the base board and the support pads; and reusing the legs.
(16) A fastening component used for any one of the above-described drum pallets includes:
a fixing lid and/or a stopper;
a rod;
a stuffing nut; and
a locking part.

Here, corrugated fiberboard generally means a plate-shaped paper product that is obtained by making paperboard strong with a multilayer structure and processed to be useable as packaging and packing materials. Corrugated fiberboard is a term of a structure formed by bonding flat paper (linerboard) and wavy paper (medium) with adhesive. Depending on the number of linerboards and mediums, corrugated fiberboard is classified into single-faced corrugated fiberboard, double-faced corrugated fiberboard, and double-wall corrugated fiberboard. In a narrow sense, corrugated fiberboard refers to these corrugated fiberboard sheets, and the original corrugated fiberboard also refers to these sheets. Corrugated fiberboard is a material used in various corrugated fiberboard products and is a sheet-shaped (plate-shaped) one in which a fluted (corrugated) medium is bonded to a linerboard and another linerboard is bonded to the back side for reinforcement. (From “Wikipedia”) Two or more corrugated fiberboard sheets can be stacked on top of each other and used. An appropriate thickness may be ensured to obtain the necessary strength.

The components such as the base board may have the top surface and bottom surface as main surfaces. The space created by the leg components and the like may be provided so that insertion components, such as the forks of a forklift, can be inserted. For example, the above-described space may be about 100 mm or higher from the floor (or the bottom surfaces of the leg components). The space may be 120 mm or higher. The space may be 150 mm or higher. If the space is too low, the insertion components cannot be inserted; whereas, if the space is too high, the height of a pallet alone or a pallet with a load may become too high. Such pallets may be inappropriate for arrangement in a container with a limited internal height. The leg component may have a support surface that bears a load from a flat plate and a spacer having a space holding function. The spacer can support the load of stacked tiles and the like to hold the space. The support surface can bear the load by contacting at least part of the bottom surface of the flat plate. The leg component may be integrally formed so as to include the spacer, the support surface, and the like. The support surface and the bottom surface may be bonded with adhesive or the like at the area of contact therebetween. The strength of the adhesion may be a strength with which the weight of the leg component can be held. For example, commercially available adhesives (which may include, for example, inorganic adhesives, organic adhesives, water-dispersion adhesives, solution adhesives, solventless adhesives, solid adhesives, and the like) may be used. The adhesion strength may be such that the adhesion can hold the own weight when the pallet is lifted by forks or the like from the bottom surface of the flat plate. When the flat plate is made of a recyclable material, such as corrugated fiberboard, the adhesion strength is preferably to such an extent that it can be easily peeled off after use. The adhesive may be, for example, adhesive, such as hot melt adhesive, that melts at high temperatures and substantially loses the adhesion strength. Mechanical joint may also be used in addition to adhesion. The mechanical joint may be, for example, a clamp or may be an attachable and detachable component, such as a hook-and-loop fastener. The material for forming may include, for example, synthetic resins such as plastics, fiber-reinforced synthetic resins, and the like. The leg component is preferably made of a recyclable or reusable material. The leg component can be removed from the flat plate to be made reusable. The leg component may be disposed near the periphery of the flat plate in a balanced manner. At least four leg components are preferably disposed to support a flat surface. For example, the leg components can be disposed respectively near the four corners of a rectangular flat plate. In the case of a pallet on which two tiles are laid flat side by side, leg components may be further provided one by one at generally the center in the longitudinal direction. These leg components preferably have the same shape. The leg components may be, for example, classified into two different shapes. Manufacturing becomes easier as the number of types of shape reduces.

### Advantageous Effects of the Invention

As described above, according to the invention of the present application, it is possible to provide the above-described drum pallet, fastening component, transport system, method of using them, and the like, so it is possible to reduce waste and environmental load.

### BRIEF DESCRIPTION OF THE DRAWINGS

FIG. 1 is a perspective view of a drum pallet in an embodiment of the present application.

FIG. 2 is a perspective view of the bottom surface of the drum pallet shown in FIG. 1.

FIG. 3 is a partially sectional view of a part where leg components are attached in the drum pallet shown in FIG. 1.

FIG. 4 is a partially sectional view of the part where the leg components are attached in the drum pallet shown in FIG. 1.

FIG. 5A is a sectional view of the leg component that is a component of a leg of the pallet in the drum pallet shown in FIG. 1.

FIG. 5B is a schematic diagram of decomposition of force of a load on the leg component in relation to the embodiment of the present invention.

FIG. 6 is a perspective view of a lid component that is a component of the leg of the pallet in the drum pallet shown in FIG. 1.

FIG. 7 is a perspective view of the lid component that is a component of the leg of the pallet in the drum pallet shown in FIG. 1.

FIG. 8 is a top view of another drum pallet in the embodiment of the present application.

FIG. 9 is a bottom view suggesting positions to attach the leg components on the drum pallet in the embodiment of the present application.

FIG. 10 is a perspective view of another drum pallet in the embodiment of the present application.

FIG. 11 is a perspective view of another drum pallet in the embodiment of the present application.

FIG. 12 is a perspective view suggesting a scene in which the leg components are attached in the drum pallet of the embodiment of the present application.

FIG. 13 is a top view of a drum.

FIG. 14 is a side view of the drum (including a partially sectional view of a protruding portion at an end of a top surface).

FIG. 15A is a perspective view showing a scene in which a hand forklift is applied to a drum pallet on which drums are mounted in the embodiment of the present application.

FIG. 15B is a schematic diagram simulating a state where forks are inserted, using the bottom view of the pallet when a hand forklift is applied to the drum pallet in the embodiment of the present application.

FIG. 15C is an exploded perspective view showing a scene in which drums are mounted on the drum pallet and these drums are fixed with a fixing lid in the embodiment of the present application.

FIG. 15D is a side view with part cut away, showing a scene in which drums are mounted on the drum pallet and these drums are fixed with the fixing lid in the embodiment of the present application.

FIG. 15E is a perspective view of the fixing lid for drums in the embodiment of the present application.

FIG. 15F is a perspective view of a stopper for tightening the fixing lid for drums in the embodiment of the present application.

FIG. 15G is a perspective view showing another embodiment of a drum pallet in the embodiment of the present application.

FIG. 15H is a bottom view showing another embodiment of the drum pallet in the embodiment of the present application.

FIG. 16A is a partial perspective view of a joint that fastens using top ends of drums in the embodiment of the present application.

FIG. 16B is a partial perspective view of another joint that fastens using top ends of drums in the embodiment of the present application.

FIG. 16C is a sectional exploded view (partially side view) of another joint that fastens using top ends of drums in the embodiment of the present application.

FIG. 16D is a partial top view of another joint that fastens using top ends of drums in the embodiment of the present application.

FIG. 16E is a partial perspective view of another joint that fastens using top ends of drums in the embodiment of the present application.

FIG. 16F is a partial perspective view of another joint that fastens using top ends of drums in the embodiment of the present application.

FIG. 16G is a partial perspective view of another joint that fastens using top ends of drums in the embodiment of the present application.

FIG. 17 is a perspective view illustrating a container generally used.

FIG. 18 is a top view of a group of drum pallets on which drums are mounted and stored in a container with a container ceiling made transparent.

FIG. 19 is a top view showing a most densely packed state by circles simulating drums.

FIG. 20 is a top view showing an ordinary loading state by circles simulating drums.

FIG. 21 is a partial sectional perspective view of a flat plate that is the material of a base board that can be a component of the drum pallet of the embodiment of the present application.

FIG. 22 is a partial sectional perspective view of a flat plate that is the material of a base board that can be a component of the drum pallet of the embodiment of the present application.

FIG. 23 is a schematic diagram illustrating a system that manages recycled pallets from a drum collection site to a drum usage site.

### MODES FOR CARRYING OUT THE INVENTION

Next, an embodiment of the present invention will be described with reference to the drawings. In the drawings, like reference signs denote components and corresponding parts having the same configuration or function, and the description thereof is omitted. In the following description, only examples of the embodiment according to the present invention are described and can be modified as needed without departing from the scope of the present invention based on the common technical knowledge of persons skilled in the art. Therefore, the scope of the present invention is not limited to these specific examples. These drawings are emphasized for illustrative purposes and may differ from actual dimensions.

### First Embodiment

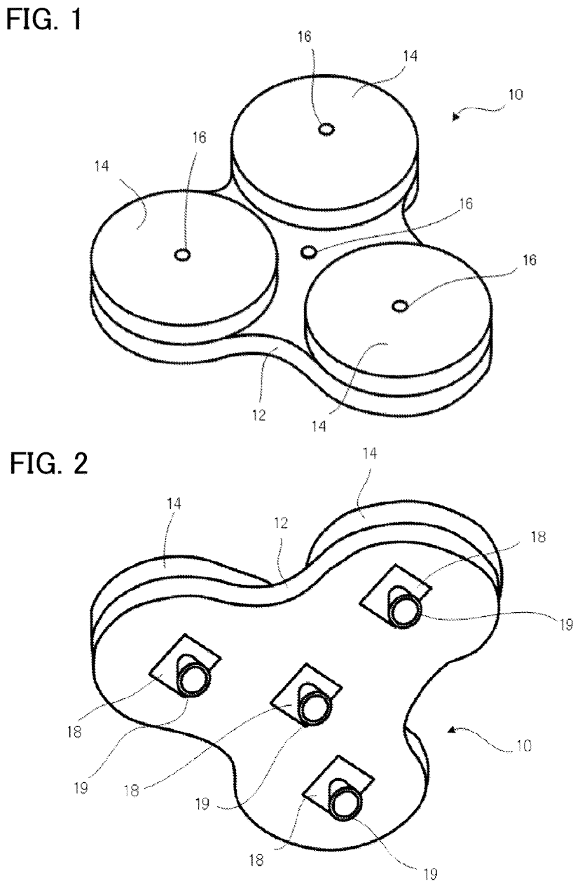

FIG. 1 is a perspective view of a pallet that is one embodiment of the invention of the present application. FIG. 2 is a perspective view of the pallet when viewed from the bottom of the pallet. The drum pallet 10 includes a base board 12 that has a three-leaf pattern in a top view, disk-shaped support pads 14 respectively at the positions of the three leaves, and four legs 19 at one center position and three substantially rotationally symmetric positions on the bottom surface side of the base board 12. The base board 12 and the support pads 14 may be made of a recyclable material, such as corrugated fiberboard. Leg attachment openings 16 are respectively provided near the centers of the base board 12 and the support pads 14. The legs 19 can bear a load from the base board 12 via leg support plates 18. Installation specifications, an installation method, and the like, will be described later. The leg 19 may be composed of reusable components. The leg 19 may be composed of recyclable materials. Typically, resin, engineering plastics, and the like, may be used. The legs 19 and/or the leg support plates 18 can be removed from the base board 12 and the like. The legs 19 and/or the leg support plates 18 may be configured to be detachable. The support pad 14 may bear the load of a mounted drum by contacting the bottom surface of the drum.

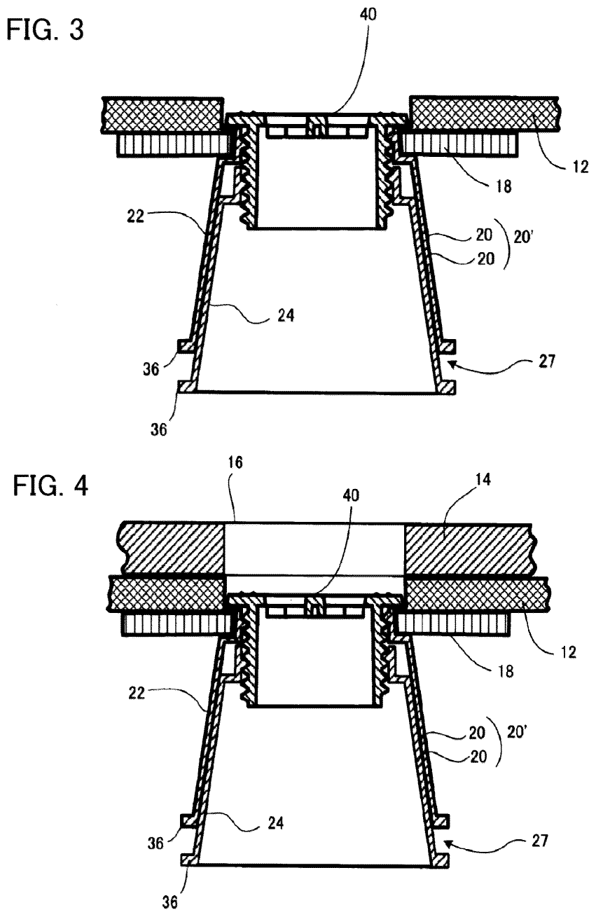

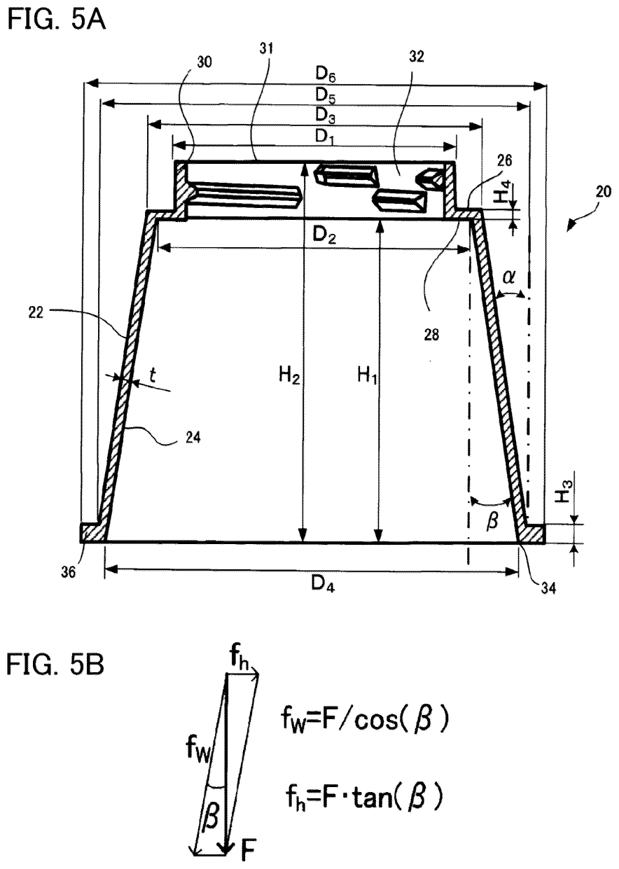

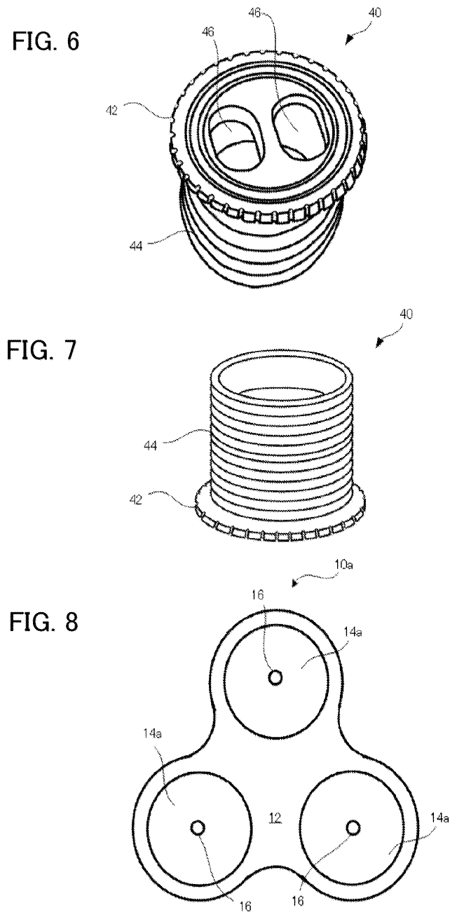

FIGS. 3 and 4 are side sectional views of an attached combined leg component 20′ that is a component of the leg composed of leg components 20, 20 stacked by inserting a top part of one of the leg components 20 into a bottom opening 34 of the other one of the leg components 20 that are component parts of the leg 19. The inserted leg component 20 and the receiving leg component 20 may have the same shape or different shapes. For example, the height of the inserted leg component 20 may be relatively low. A thread 44 of a common lid component 40 is screwed into a partial internal thread 32 of a thin-walled cylindrical part 30 of the inserted leg component 20 and is screwed into a corresponding partial internal thread 32 of the receiving leg component 20 (see FIGS. 6 and 7). In this way, the combined leg component 20′ composed of the leg components 20, 20 becomes one, and the load as described above is transmitted from an inner surface 24 of the receiving leg component 20 via an outer surface 22 of the inserted leg component 20 that is in contact with the inner surface 24, and is supported by and transmitted to a side wall of the inserted leg component 20. The load is transmitted from the bottom surface of the inserted leg component 20 to the installation surface (the surface on which the pallet is put), and the installation surface supports the weight of the drum pallet 10 including mounted objects. Each of the leg components 20 has a substantially thin-walled hollow right circular truncated cone shape. The leg component 20 has an annular mounting surface 26 at the top part of the circular truncated cone and a substantially vertically upright thin-walled cylindrical part 30 provided at the inner annular part of the mounting surface 26. The top end has an annular shape (FIG. 5A). The above-described load may be transmitted from the lower surface of the annular part of the mounting surface 26 of the receiving leg component 20 to the top end of the thin-walled cylindrical part 30 of the inserted leg component 20. As is apparent from FIGS. 3 and 4, these are substantially in contact with each other. In the combined leg component 20′, the height of the inserted leg component 20 may be such that the bottom surface of a ring component 36 of the receiving leg component 20 does not contact the top surface of a ring component 36 of the inserted leg component 20. The bottom surface and top surface of the ring components 36 may deform to contact each other due to the weight of the drum pallet 10 on which mounted objects are mounted. There may be a gap 27.

A state where the thin-walled cylindrical part 30 of the leg component 20 is inserted in the opening of the leg support plate 18 and the opening of the base board 12, mounted on the mounting surface 26 in this order, and the lid component 40 is screwed in the partial internal thread 32 of the thin-walled cylindrical part 30 is shown in a sectional view. The leg support plate 18 and the base board 12 are sandwiched between a head 42 of the lid component 40 and the mounting surface 26. At this time, no other elements like adhesive or fastening components are needed. This is because the frictional force and clamping force between the outer periphery of the thin-walled cylindrical part 30 and the opening and the side face of the opening are sufficient to hold the leg components 20 (and the lid component 40). However, sticky material may be used as a supplement. The leg components 20 support the load of the mounted objects (such as drums) mounted on top of the leg components 20, the base board 12, and the like, in a manner such that the bottom surface of the bottom opening contacts the installation surface (the surface on which the pallet 10 is installed). The lid component 40 is mainly composed of the head 42 and the thread 44. The thread 44 is screwed into the partial internal thread of the thin-walled cylindrical part extending in the same direction about the conical axis at the upper opening of the leg component 20. Two annular projections are provided on the upper surface of the head 42 so as to be spaced apart in a substantially concentric manner. The load of the mounted objects mounted on the base board 12 of the pallet 10 is transmitted to the mounting surfaces 26 via the base board 12 and the leg support plates 18. Then, the load is supported by and transmitted to the side walls defined by the outer surfaces 22 and inner surfaces 24 of the leg components 20, transmitted from the bottom surface to the installation surface, and the installation surface supports the weight of the pallet 10, including the mounted objects, on the installation surface. The load may be transmitted from the lower surface of the annular part of the mounting surface 26 of the receiving leg component 20 to the top end of the thin-walled cylindrical part 30 of the inserted leg component 20. The ring component 36 is provided at the outer periphery of the bottom opening of each leg component 20, and the ring components 36 make up the bottom surface together.

A side sectional view of the attached combined leg component that is a component of a combined leg 30′ composed of the leg components 20, 20 stacked by inserting the top part of the leg component 20 to the bottom opening of the leg component 20 is shown. The inserted leg component 20 has substantially the same shape. The thread 44 of the common lid component 40 is screwed into the corresponding partial internal thread 32 of the receiving leg component 20 and is screwed into the partial internal thread 32 of the thin-walled cylindrical part 30 of the inserted leg component 20. In this way, the combined leg component composed of the leg components 20, 20 becomes one, and the load as described above is transmitted from the inner surface 24 of the receiving leg component 20 via the outer surface 22 of the inserted leg component 20 that contacts the inner surface 24 and is supported by and transmitted to the side wall of the inserted leg component 20. The load may be transmitted from the lower face of the annular part of the mounting surface 26 of the receiving leg component 20 to the top end of the thin-walled cylindrical part 30 of the inserted leg component 20. Then, the load is transmitted from the bottom surface of the inserted leg component 20 to the installation surface, and the installation surface supports the weight of the pallet 10, including mounted objects. At this time, the height of the inserted leg component 20 may be such that the bottom surface of the ring component 36 of the receiving leg component 20 does not contact the top surface of the ring component 36 of the inserted leg component 20. The bottom surface and top surface of the ring components 36 may deform to contact each other due to the weight of the pallet 10 on which mounted objects are mounted. There may be a gap. The gap is preferably 20 mm or less. The gap is preferably 15 mm or less. The gap may be 10 mm or less.

FIG. 5A is a sectional view showing the configuration of the leg component 20 that is a component of the leg 19 that can be a component of a drum pallet in more detail according to one embodiment of the invention of the present application. The leg component 20 may be combined with another leg component 20 to make up the combined leg component 20′ or may make up the leg 19 alone. The leg component 20 basically has a thin-walled hollow right circular truncated cone shape. The leg component 20 has the bottom opening 34 at the bottom, the annular mounting surface 26 at the top part of the circular truncated cone, the substantially vertically upright thin-walled cylindrical part 30 provided at the inner annular part of the mounting surface 26, the upper opening 31 that is the opening of the thin-walled cylindrical part 30, the inclined outer surface 22, the inclined inner surface 24, and the annular ring component 36 at the bottom opening 34. The inside diameter of the bottom opening 34 is a diameter D4, the inside diameter of the top part of the circular truncated cone is a diameter D2, the inclination angle of the outer surface 22 is a degrees with respect to the conical axis, and the inclination angle of the inner surface 24 is B degrees with respect to the conical axis. The inside diameter of the annular mounting surface 26 is D1, and the outside diameter is D3. Therefore, the area of the mounting surface 26 is π[(D3/2)\hat{ }2−(D1/2)\hat{ }2]. The thin-walled cylindrical part 30 includes the partial internal thread 32 with a plurality of protrusions on the inner side of the cylindrical shape. These projections are formed by partially breaking a helical recess that is a component of an internal thread. A suitable external thread can be screwed here to fix the leg component 20. The inside diameter of the ring component 36 is D5, and the outside diameter is D6. The height of the hollow part of the hollow leg component 20 is H1, and the height of the leg component 20 including the thin-walled cylindrical part 30 is H2. To satisfy the above-described relationship, these dimensions preferably have certain rules.

The basic shape of the leg component 20 can generally be defined by the inside diameter D4 of the bottom or large-diameter part, (Outer inclination angle α)≥(Inner inclination angle β), thickness t, and internal height H1. Here, the thickness t may be the same as the height H4 of the central annular part of a small-diameter part. The thickness t can be determined by multiplying the difference between the inside diameter and the outside diameter at the same height by the cosine of the inclination angle. In other words, where the height from the bottom surface is y, the difference between the outside diameter Dout(y) and the inside diameter Din(y) at a certain height H(y) may be multiplied by cos(α(≥β))(t=(Dout(y)-Din(y))×cos(α or β)). Here, substantially α=β is preferable. It is applicable that α>β. It is also applicable that α≤1.1×β. The annular ring component 36 may be another component such that an annular ring is fitted to a base part of the hollow circular truncated cone (which may include an O-ring-like hoop or the like) that fits into the base part of the hollow circular truncated cone or may be integrally formed. The distinctive dimensions are an outer peripheral diameter D6 and a thickness (or height) H3.

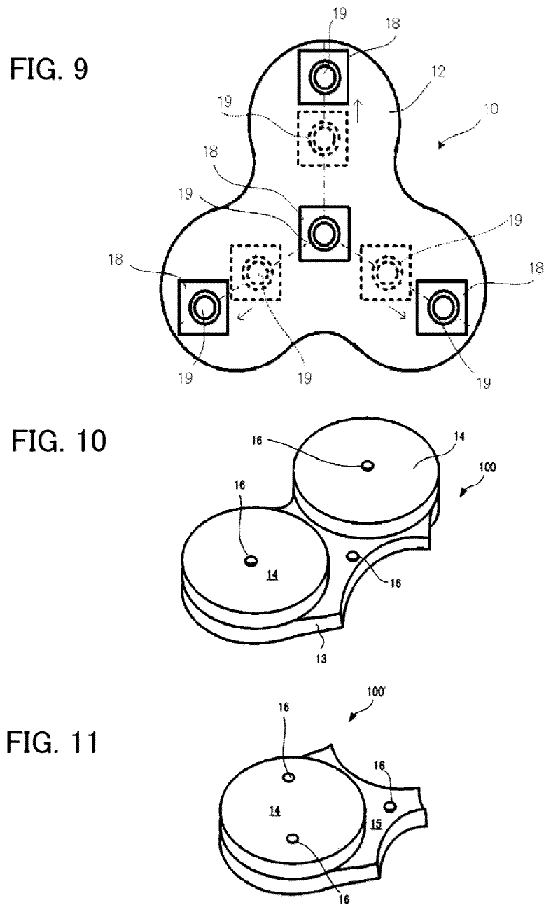

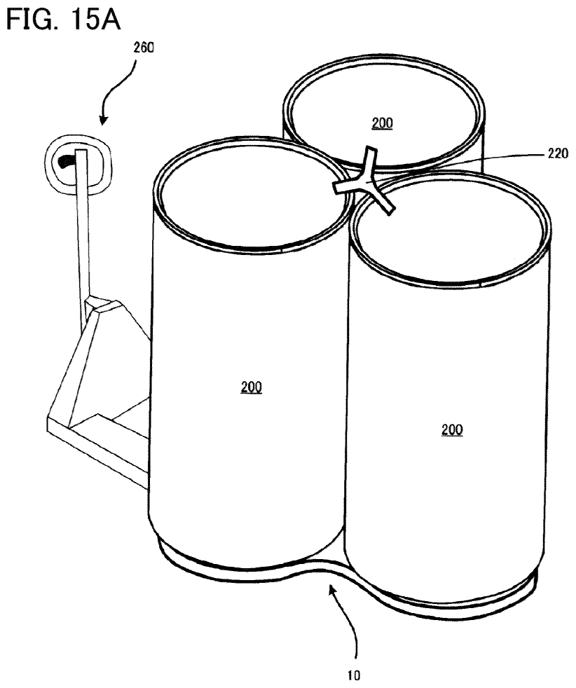

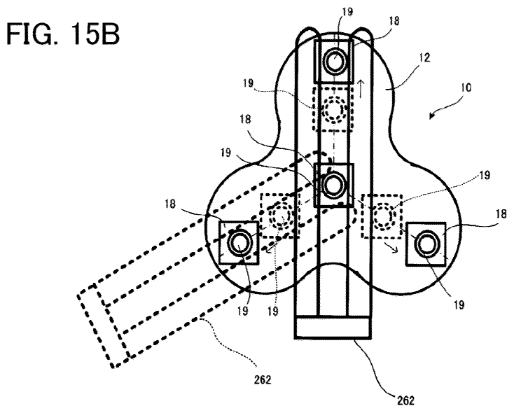

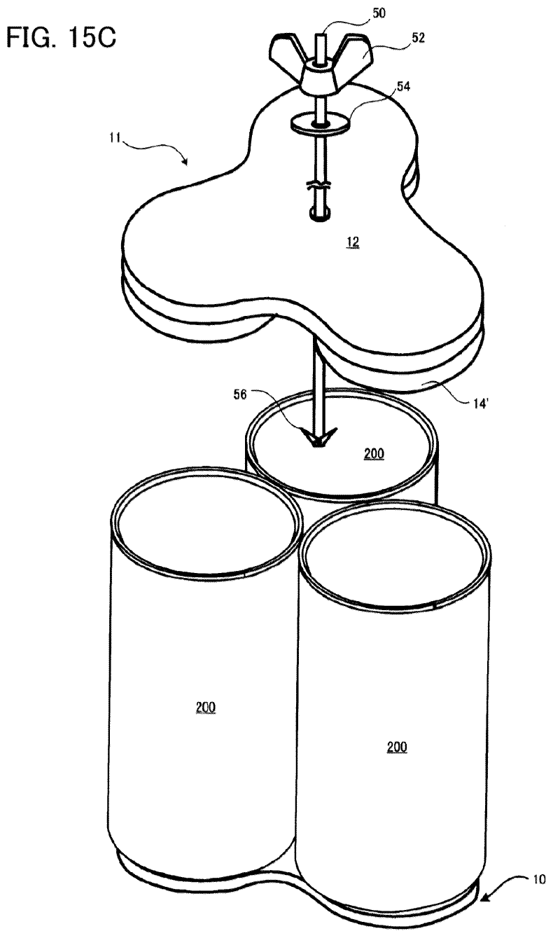

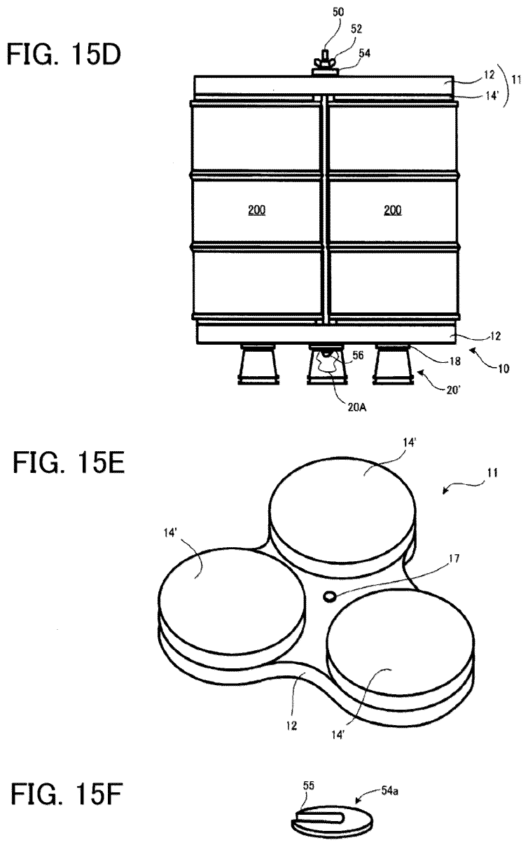

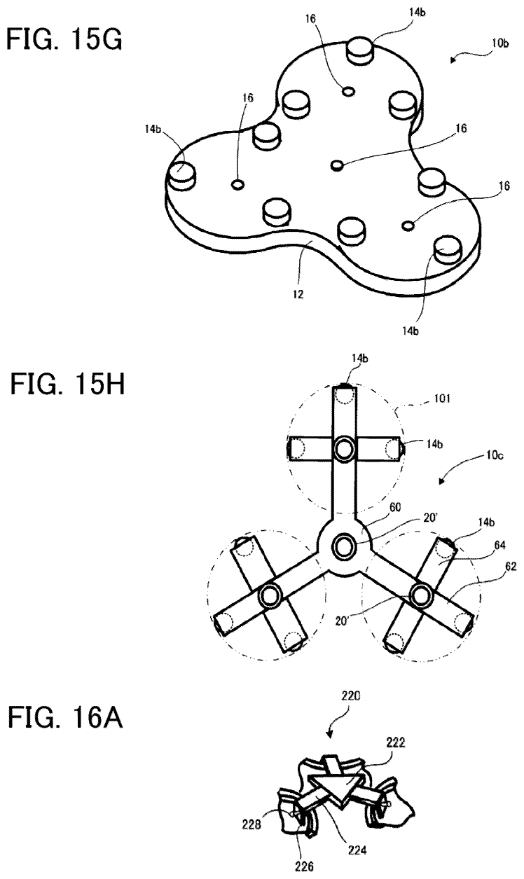

Each of the leg components 20 that are components of the drum pallet has a function to hold a space where the tines (forks) of a forklift or the like can be inserted. For this reason, the leg component 20 preferably has a height (for example, H1) to such an extent that tines can be inserted. Specifically, H1≥50 mm is preferable. It is preferable that H1≥70 mm. It is preferable that H1≥80 mm. It is preferable that H1≥100 mm. On the other hand, it is not preferable that the height is unnecessarily too high because the maximum load capacity decreases. For example, it is preferable that H1≤700 mm. It is preferable that H1≤500 mm. It is preferable that H1≤300 mm. It is applicable that H1≤200 mm. For example, as for commercially available hand forklifts, the height of lift is generally in the range of 60 mm to 200 mm, the length of the forks is generally in the range of 1000 mm to 1200 mm, the width of the forks is generally in the range of 150 mm to 200 mm, and the spacing between the tines is generally in the range of 190 mm to 230 mm. For example, in the case of the pallet as shown in FIGS. 1 and 2, it is apparent that mounted three drums are easily lifted up stably when the central leg 19 is placed between the forks (between the tines). The distance between the legs 19 disposed below the two drums is typically the length of the diameter of the drum+α (gap or the like), so the central leg 19 and the leg 19 disposed below one of the drums may be placed between the forks. In such a case, the sum of the distance between the forks and the width of the two forks is presumably typically in the range of 400 mm to 500 mm, so, as shown in FIG. 15B, the forks can be inserted in a 120-degree rotational symmetric manner. In this way, there is a high degree of flexibility in the insertion direction. As discussed with reference to FIG. 9, the insertion state of the forks in a case where the positions of the legs are shifted can be roughly simulated.

The outside diameter D5 or D6 or the inside diameter D4 that corresponds to the thickness of the leg component 20 that is a component of an assembled pallet that is a drum pallet influences the load-bearing performance of the leg component 20. The thickness t may be defined by D4, D5, H3, and β (or α). For example, it may be t=(D5−D4+2×H3·tan(β))/2·cos(α or β). Where α=β=5 degrees, H3=5 mm, D4=100 mm, and D5=106 mm, it may be t=3.4 mm. For example, the compressive strength of polypropylene is approximately 40 MPa, so the leg component 20 may be crushed by about one ton. When the diameter is doubled with the inclination angle α (and β) and the thickness t kept constant, the supporting area doubles, so the load bearing improves. However, if the thickness of the leg component 20 is too large, there is a possibility that the functionality of a cargo pallet decreases since the insertion space for the tines (forks) of a forklift or the like is maintained. Specifically, it is preferable that D4≥30 mm. It is preferable that D4>40 mm. It is preferable that D4>50 mm. It is preferable that D4>60 mm. It is preferable that D4>70 mm. It is preferable that D4≥80 mm. It is preferable that D4>90 mm. In consideration of functionality, it is preferable that D4≤300 mm. It is preferable that D4≤250 mm. It is preferable that D4≤230 mm. It is preferable that D4≤210 mm. It is preferable that D4≤200 mm. It is preferable that D4≤190 mm.

The thickness t directly influences the load-bearing area, and in a simplified manner, when the thickness t is multiplied by the length of a circumference that is the outer shape of the hollow circular truncated cone, the calculated result is equivalent to the load-bearing area. As the thickness t reduces, the weight of the leg component 20 can be reduced. However, in consideration of a support load, it is difficult to make up an assembled pallet if the thickness t is too thin. From the viewpoint of ease of manufacturing, the thickness t is preferably not too thin. On the other hand, if the thickness t is too thick, there is a possibility that it becomes difficult to use the stacked leg components 20. There is a possibility that the weight becomes excessive. The thickness t may be determined individually in consideration of necessary load bearing and the like. For example, it is preferable that t≥0.5 mm. It is preferable that t≥0.7 mm. It is preferable that t≥0.9 mm. It is preferable that t≥1 mm. It is preferable that t≥1.2 mm. It is preferable that t≥1.3 mm. It is preferable that t≥1.5 mm. It is preferable that t≥2 mm. On the other hand, it is preferable that t≤10 mm. It is preferable that t≤8 mm. It is preferable that t≤7 mm. It is preferable that t≤6 mm. It is preferable that t≤5 mm. It is preferable that t≤4 mm. It is preferable that t≤3 mm. Incidentally, the thickness t may be defined based on a relative ratio to the inside diameter D4 (or the outside diameter D5 or D6). For example, the thickness t may be greater than or equal to 1% of the inside diameter D4, may be greater than or equal to 1.2% of the inside diameter D4, may be greater than or equal to 1.4% of the inside diameter D4, may be greater than or equal to 1.5% of the inside diameter D4, or may be greater than or equal to 1.6% of the inside diameter D4. For example, the thickness t may be less than or equal to 10% of the inside diameter D4, may be less than or equal to 9% of the inside diameter D4, may be less than or equal to 8% of the inside diameter D4, may be less than or equal to 7% of the inside diameter D4, or may be less than or equal to 6% of the inside diameter D4.

(Outer inclination angle α)≥(Inner inclination angle β) is important when two or more leg components 20 of the same shape are stacked and used. The outer inclination angle α is preferably substantially equal to or slightly larger than the inner inclination angle β. When two or more legs components 20 of the same shape are stacked, the top of the leg component 20 (for example, the outside diameter indicated by D3) is inserted into the opening at the bottom (for example, the inside diameter indicated by D4), and the outer surface 22 of the leg component 20 inserted (hereinafter, “inserted leg component”) contacts the inner surface 24 of the leg component that receives the inserted leg component (hereinafter, “receiving leg component”) to block further insertion. At this time, when the outer inclination angle α is particularly smaller than the inner inclination angle β, the top of the outer surface 22 contacts the inner surface 24, but the bottom of the outer surface 22 may be difficult to contact the inner surface 24. Therefore, there is a possibility that the support load is applied to only the top of the outer surface 22 of the inserted leg component and the inner surface 24 of the corresponding receiving leg component to generate excessive contact pressure. For example, the outer inclination angle α is preferably larger than or equal to 0.9 times the inner inclination angle β. The outer inclination angle α is preferably larger than or equal to 0.95 times the inner inclination angle β. The outer inclination angle α is preferably larger than or equal to 0.97 times the inner inclination angle. The outer inclination angle α is preferably smaller than or equal to 1.2 times the inner inclination angle β. The outer inclination angle α is preferably smaller than or equal to 1.1 times the inner inclination angle β. The outer inclination angle α is preferably smaller than or equal to 1.05 times the inner inclination angle β. For example, it is preferable that β≥1 degree. It is preferable that β≥1.2 degrees. It is preferable that β≥1.4 degrees. It is preferable that β≥1.5 degrees. It is preferable that β≥1.7 degrees. It is preferable that β≥1.9 degrees. It is preferable that β≥2 degrees. On the other hand, if the inclination angle is too large, there is a possibility that the load along the wall, applied to the side wall defined by the outer surface 22 and the inner surface 24, becomes excessive. For example, as shown in FIG. 5B, the support load F of the leg component 20 may be decomposable into the force fw along the side wall and the force fh directed toward the center of the circle in a top view of the circular truncated cone in the horizontal direction in cross section. fw may correspond to the one obtained by dividing the support load F by cos(β). For example, when β is 3 degrees, 1/cos(β) is 1.001372346, fw is almost equal to the support load F, tan(β) is 0.052407779, and fh is about 5% of the support load F. As shown in Table 1, up to about 6 degrees of β, fw and fh do not change much, but, when β exceeds 7 degrees, particularly, fh increases to about 12% of F. When β exceeds 10 degrees, fh increases to about 17% of F. A rate of increase in fw increases when β exceeds 45 degrees. Therefore, it is preferable that β≤45 degrees. It is preferable that β≤35 degrees. It is preferable that β≤30 degrees. It is preferable that β≤25 degrees. It is preferable that β≤20 degrees. It is preferable that β≤15 degrees. It is preferable that β≤10 degrees.

In the case where α=β, where the thickness is t, an area in which a part around the outer surface of the inserted leg component can be inserted into the bottom of the receiving leg component with the inside diameter D4 is up to a position that is y (mm)≥t/2/sin α from the bottom opening surface of the inserted leg component. For example, when α=β=1.5 degrees and t=3 mm, the inserted leg component can enter from its top part into the hollow part of the receiving leg component to a depth of 57.30 mm from the bottom opening surface. When H1 corresponding to the height of the hollow part is 100 mm, the inserted leg component and the receiving leg component may overlap each other up to (100−57)/100=43%. The overlapping area transmits the support load from the top of the receiving leg component to the inserted leg component, and an annular surface defining the bottom opening of the inserted leg component transmits the support load to the installation surface. When the overlapping area is too small, there is a possibility that transmission of power is in a bad condition. On the other hand, when the overlapping area is too large, it is necessary to reduce the thickness t and/or increase the inclination angle. Therefore, there is a possibility that the supportable load becomes too small. Generally, it is preferable that the overlapping area is larger than or equal to 40% of H1 corresponding to the height of the hollow part. It is preferable that the overlapping area is larger than or equal to 50%. The overlapping area may be larger than or equal to 60%. The overlapping area may be larger than or equal to 70%. The overlapping area may be larger than or equal to 80%. On the other hand, considering mechanical strength, thickness t, and inclination angle, it is preferable that the overlapping area is smaller than or equal to 99%. It is preferable that the overlapping area is smaller than or equal to 98%. The overlapping area may be smaller than or equal to 97%. The overlapping area may be smaller than or equal to 95%. The overlapping area may be smaller than or equal to 93%. The overlapping area may be smaller than or equal to 91%. The overlapping area may be smaller than or equal to 90%.

When H1 corresponding to the height of the hollow part is in the range of 50 mm≤H1≤200 mm, the overlapping area is preferably up to a position 20 mm from the bottom opening surface of the inserted leg component. The overlapping area is preferably up to a position 25 mm. The overlapping area is preferably up to a position 30 mm. On the other hand, because it is preferable that the thin-walled cylindrical part 24 at the top part of the circular truncated cone does not contact, it is preferable that the overlapping area is larger than H2−H1.

TABLE 1

| β(deg) | 1/cos(β) | tan(β) |
|---|---|---|
| 3 | 1.001372 | 0.052408 |
| 4 | 1.002442 | 0.069927 |
| 5 | 1.00382 | 0.087489 |
| 6 | 1.005508 | 0.105104 |
| 7 | 1.00751 | 0.122785 |
| 8 | 1.009828 | 0.140541 |
| 9 | 1.012465 | 0.158384 |
| 10 | 1.015427 | 0.176327 |
| 12 | 1.022341 | 0.212557 |
| 14 | 1.030614 | 0.249328 |
| 15 | 1.035276 | 0.267949 |
| 17 | 1.045692 | 0.305731 |
| 19 | 1.057621 | 0.344328 |
| 20 | 1.064178 | 0.36397 |
| 25 | 1.103378 | 0.466308 |
| 27 | 1.122326 | 0.509525 |
| 30 | 1.154701 | 0.57735 |
| 35 | 1.220775 | 0.700208 |
| 40 | 1.305407 | 0.8391 |

In the above description, transfer of load on the side surfaces when two leg components 20 are stacked has been described. The load can be transmitted not only by the contact of the side surfaces but also by the contact of the mounting surface 26 or the bottom surface 28 of the mounting surface and the top surface of the thin-walled cylindrical part 30. The major load may be transmitted by the contact.

FIGS. 6 and 7 are perspective views showing the lid component 40. The lid component 40 is composed of the head 42 and the thread 44. The head 42 has two openings 46 to allow easy rotation.

FIG. 8 is a top view of a drum pallet 10a. This pallet shows that support pads 14a are smaller than the outer edge of the base board 12. At this time, drums to be mounted may extend beyond the outer edge of the base board 12 or do not need to extend beyond the outer edge of the base board 12. The support pad 14a has a sufficient size to support the major load of the drum. The legs 19 disposed below the support pads 14a are placed below the leg attachment openings 16 and support the load of the drums.

FIG. 9 is a bottom view of the drum pallet 10. Here, in a modification, the positions of the legs 19 are disposed on the outer side of the positions of FIG. 8. At this time, considering the overall balance, the legs 19 may be shifted outward so as to be in a 120-degree rotational symmetric manner in the support pads 14 deployed in a three-leaf manner. In this way, when three drums are mounted, it is presumable that tension easily works on the base board 12. Movement with such arrangement is also possible.

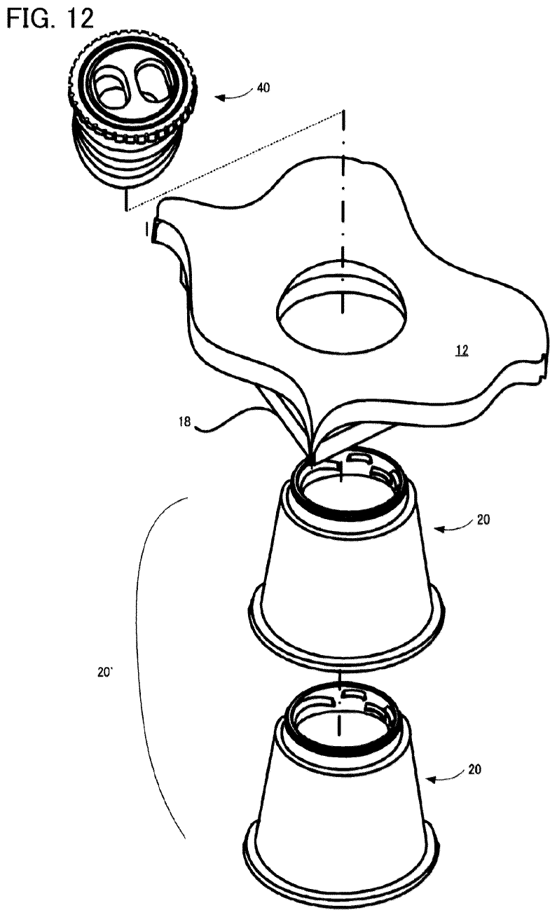

FIG. 10 is a perspective view of a two-drum pallet 100 as a modification of the drum pallet. This is an example in which one leaf is removed from the three-leaf pallet shown in FIG. 1. At this time, drums (two) are supported by the legs 19 respectively disposed at the centers of the support pads 14 and the leg 19 at the center of the three-leaf shape shown in FIG. 1. FIG. 11 is an example 100′ in which two leaves are removed from the three-leaf pallet shown in FIG. 1. At this time, one drum is supported at three points by the legs 19 disposed not at the center of the support pad 14 and the leg 19 at the center of the three-leaf shape shown in FIG. 1.

FIG. 12 is an exploded perspective view illustrating a scene in which the two leg components 20 are stacked to form the combined leg component, the thin-walled cylindrical part of the top part of the receiving leg component 20 extends through the opening of the leg support plate and the opening of the base board 12, and the lid component 40 is screwed into the partial internal thread from above. The base board 12 is mounted on the mounting surface 26 of the upper leg component 20 to support a mounted object mounted on the base board 12. The head 42 of the lid component 40 has two openings 46 that function as locking parts to assist in screwing the lid component 40 into the partial internal thread and turning the lid component 40 to remove from the partial internal thread. The outer periphery of the head 42 has a knurling that functions as a friction component. FIG. 12 is a perspective view of the lid component 40 and the leg components 20 that are arranged in an engaging direction. The leg component 20 has an knurling that provides an anti-slip function.

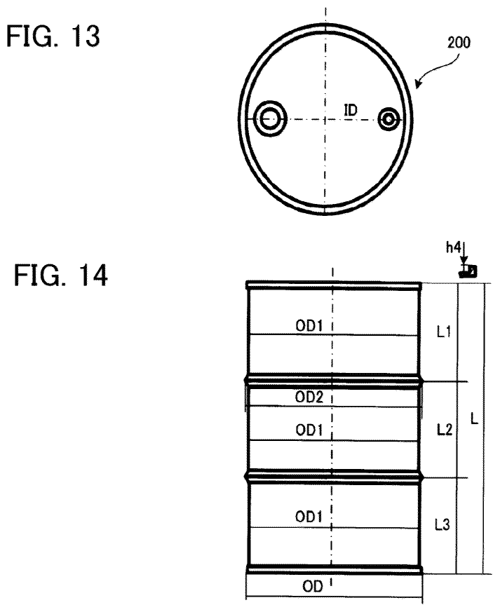

FIGS. 13 and 14 are a top view and a side view of a drum. The drum 200 is a typical drum of more than 212 liters and is defined in, for example, JIS Z 1601. For example, the inside diameter of the drum is about 566±2 mm, the outside diameter OD is about 585 mm, and the height L is about 890±5 mm. A chime (h4) is about 22±3 mm.

FIG. 15A is a perspective view showing the drum pallet 10 on which the drums 200 are mounted, together with a movable hand forklift 260. The three drums are arranged in a so-called closest packing manner (a manner in which a third drum is placed in a recess defined by two drums). A joint (fastening component) 220 is provided to hook the edge parts of the tops of the three drums 200 on one another to connect the third drum. The fastening component preferably has a predetermined tensile strength because the fastening component supports (or restrains) the third drum from coming off. For example, the fastening component may be made of the same material as the legs 19.

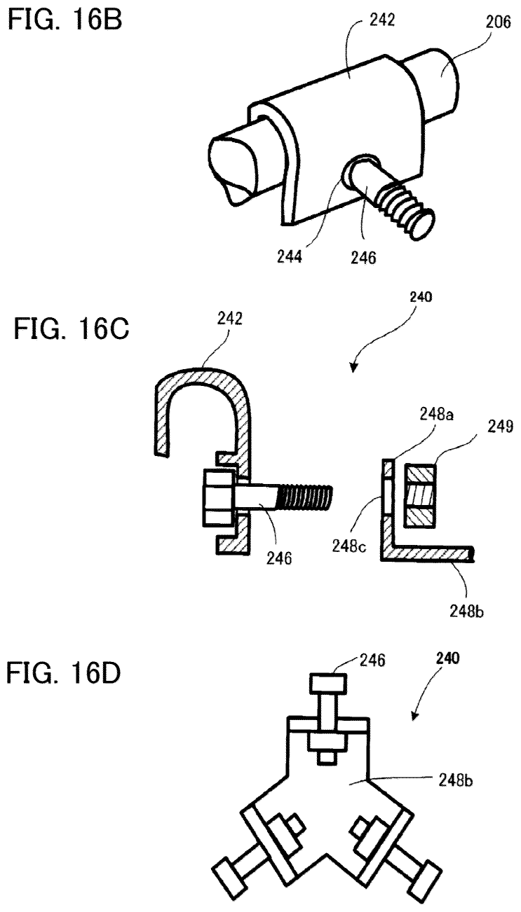

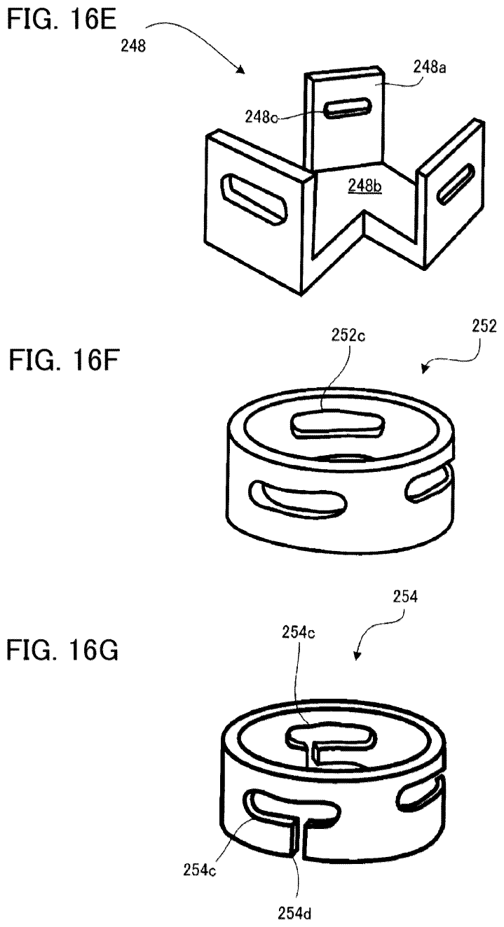

FIG. 16A is a perspective view of one embodiment of the joint (fastening component) 220. The joint 220 has a hub 222 at the center with a triangular shape in a top view. Arms 224 extend radially in a 120-degree rotational symmetric manner and each have a hook 226 at its tip. The joint 220 includes adjustment components (for example, bolts) 228 for fastening to the top edges of drums. These components may be made of metal or the like because a predetermined tensile strength is required. These components may be made of the same material as the legs 19 (the adjustment components may be made of metal).

FIGS. 16B to 16E illustrate another joint (fastening component) 240. The joint 240 includes a mount part 242 (which corresponds to a hook) for mounting by hooking on the top edge (chime) 206 of a drum, an opening 244 on a radially inner side, a bolt 246 (which corresponds to an arm) disposing the head of the bolt on a radially outer side and extending through the opening 244, a bracket 248 that is a component of a hub, and a nut portion 249 that is a counterpart of the bolt 246. The bracket 248 includes a central part 248b and 120-degree rotationally symmetric upright parts 248a. Each of the upright parts 248a has a lateral hole 248c through which the bolt 246 extends (passes). FIGS. 16F and 16G show other embodiments of the bracket. Cylindrical brackets 252, 254 are highly versatile, and openings 252c, 254c are elongated laterally and allow fastening components, such as bolts, to pass through in a versatile manner. An opening 254d is open as a passage for an arm (for example, the bolt 246) to allow the arm to be covered from above. Each bracket can be a component of the fastening component 240.

FIG. 15C is an exploded perspective view showing a scene in which drums are mounted on the drum pallet and these drums are fixed with a fixing lid in the embodiment of the present application. The procedure up to when drums are mounted on the drum pallet 10 is the same as that of FIG. 15A, so the description thereof is omitted. The fixing lid 11 is brought close from above the three-mounted drums 200 such that the fixing lid 11 covers the drums 200 with fixed pads 14′ facing downward. As shown in FIG. 15E, the fixing lid 11 is similar to the drum pallet shown in FIG. 1. The difference is that the fixed pads 14′ are mounted and fixed on the base board 12 and no legs 19 are provided. A through-hole 17 is provided at the center; however, the through-hole 17 is provided to allow a threaded rod 50 for fixing the drums to pass through. The threaded rod 50 is at least partially threaded and can tighten the fixing lid 11 via a washer 54 with a stuffing nut like a butterfly nut. A locking part 56 is provided at the lower tip of the threaded rod 50. The locking part may be inserted into any one of the openings 46 of the lid component 40 and fixed to the inner side edge of the opening 46 so as not to come off. The locking part 56 may have a tip deployment part or may have a tip fixing crossbar. FIG. 15D is a side view showing a drum pallet system in which drums fixed by the fixing lid 11 are mounted. The inside of the center combined leg component 20′ is allowed to be seen through with part cut away. When drums are fixed in this way, the drums can firmly withstand against rolling.

When the washer 54 is large enough, it is clear that the drums can be fixed even without the fixing lid 11. The washer 54 does not necessarily need to be annular and may be a stopper 54a with a notch (opening) 55 as shown in FIG. 15F. The washer 54 does not need to be circular and may have a horseshoe shape.

FIG. 15G is a perspective view showing another embodiment of the drum pallet in the embodiment of the present application. Up to here, the support pads 14 attached to the base board 12 each have a circular shape (disk shape) so as to be placed in the radially inner side of a recess on the top surface of each drum; however, the support pad 14 does not need to be circular as long as the support pad 14 can support the load. For example, like a drum pallet 10b shown in the drawing, the drum pallet 10b may include the support pads 14b having a small disk shape three by three. The reason why three support pads 14b are provided is to stably support drums. In other words, since a plane can be determined by three points, when small pads (which do not need to have a disk shape and may be rectangular), three or more points are preferably used. A recycled material has been used for support pads so far; however, the support pads are not limited thereto. The support pads may be made of wood. The support pads may be made of metal. The support pads may be made of resin. The support pads may be made of other materials or composite materials.

FIG. 15H is a bottom view showing another embodiment of the drum pallet in the embodiment of the present application. The base board 12 has been described as being made of a recycled material; however, the base board 12 is not limited thereto. The base board 12 may be made of wood. The base board 12 may be made of metal. The base board 12 may be made of resin. The base board 12 may be made of other materials or composite materials. The base board having a three-leaf shape composed of three circles (to which the shape of drums in a top view corresponds) in a top view has been described; however, the shape of the base board is not limited thereto. For example, the base board may have a hub-and-spoke shape like a drum pallet 10c shown in the drawing. In the drawing, a part corresponding to the base board is composed of a base part 60 (corresponding to a hub), spoke parts 62 (corresponding to spokes) extending radially in three directions from the base part 60, and cross boards 64 (also corresponding to the spokes) orthogonal to these spoke parts 62. The base part 60, the spoke parts 62, and the cross boards 64 may have a plate shape. The three imaginary lines 101 drawn with the alternate long and two short dashed lines correspond to the circular shapes of the radially inner sides of the bottom surfaces of the drums. Support pads 14b are provided on the top surfaces of the spoke parts 62 and cross boards 64 along these lines. These support pads 14b are similar to those of FIG. 15G.

These base part 60, spoke parts 62, and cross boards 64 have a small area in a top view, so a recycled material like paper may have insufficient strength. For example, these parts may be made of wood, metal, or resin. These parts made of wood, metal, or resin mainly have a thin plate shape, so recycling is presumably relatively easy. Of course, these parts may be recycled into recycled materials. The parts may be disposed of after use like one-through.

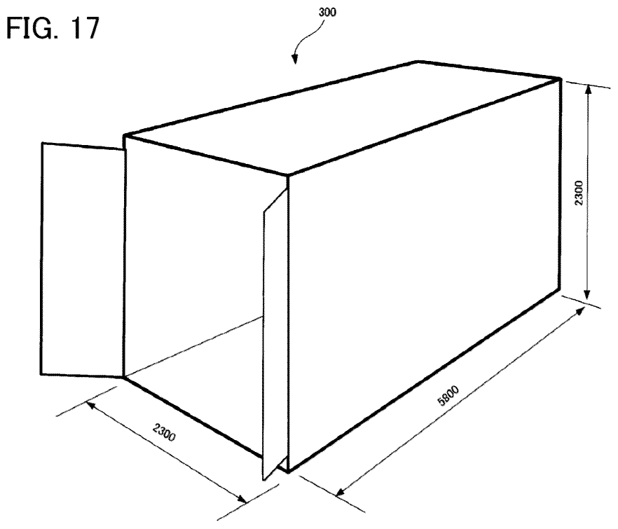

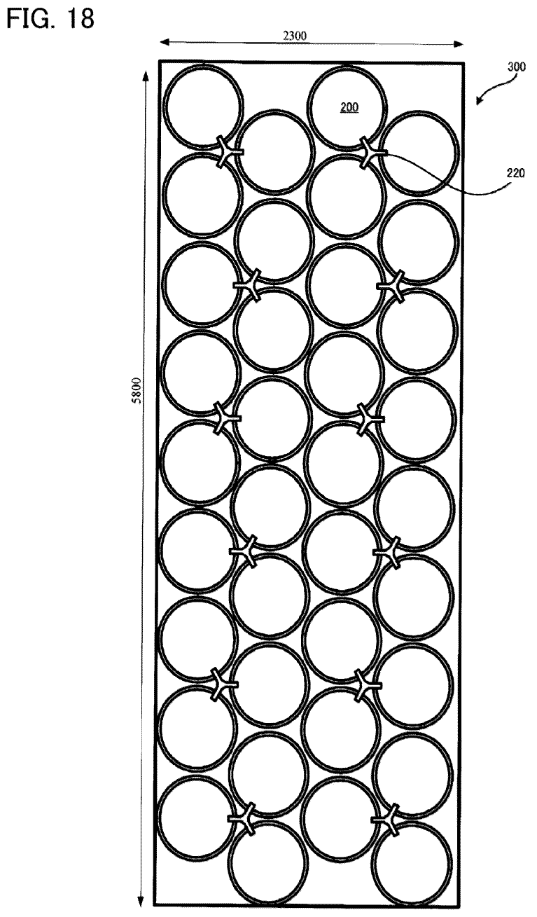

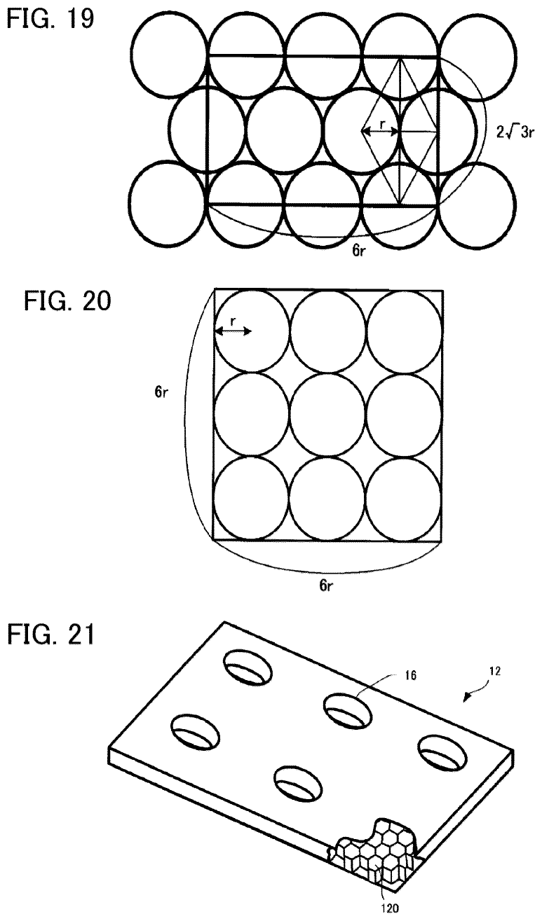

FIG. 17 shows a container 300 generally used for transportation by ship or the like. A cluster of mounted pallets as shown in FIG. 15A is arranged in the container of FIG. 17, and FIG. 18 illustrates a top view thereof. When arranged in this way, the packing efficiency of drums dramatically improves. Ordinarily, as shown in FIG. 20, drums are mounted in a so-called non-closest packing manner. Assuming that drums are mounted on a 3×3 arrangement pallet, one side needs a length six times the radius r of a drum as shown in FIG. 20. On the other hand, in the case of a so-called closest packing manner, as shown in FIG. 19, the packing efficiency can be improved by 15%. In addition, since the closest packing structure is provided, drums are in mesh with each other and do not shift from each other. On the other hand, with the configuration as shown in FIG. 20, restraint of drums from each other almost cannot be expected. Furthermore, as shown in FIG. 18, when drums mounted on the drum pallets of the present application are loaded into the container 300, the drums can be mounted on the container 300 without changing pallets, such as single-load and double-load pallets. In addition, while the internal dimensions of a typical container are 2300×5800, only 3×9=27 items can be stored in the stacking method as shown in FIG. 20. However, with the drum pallets of the present application, 36 items can be stored. This is because of gaps based on the typical dimensions of a typical container; however, an increase in loading efficiency of 30% or more is expected. Furthermore, for example, assuming that the height of a drum is typically about 900 mm and the height of a pallet is typically about 150 mm, the internal dimension height of the container is 2300, so double stacking is also possible. When tightly loaded in this way, the inner wall of the container can directly support drums against shaking during container transport. Therefore, no separate fasteners, such as lashing belts, may be needed.

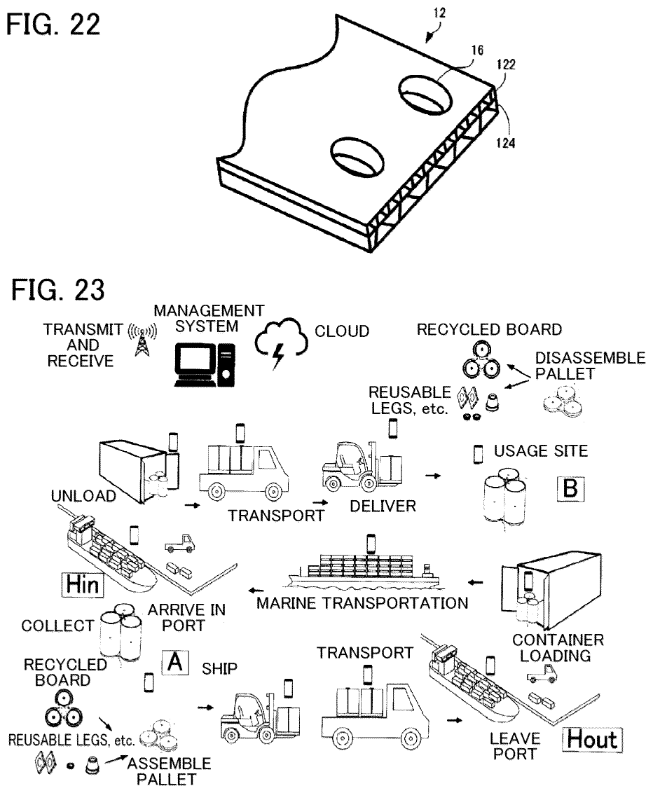

FIGS. 21 and 22 illustrate a sheet material that can make up the base board 12. FIG. 22 illustrates a corrugated fiberboard (which may be made of paper or may be made of resin) with double flutes consisting of small flutes 122 and large flutes 124. This corrugated fiberboard may have openings. FIG. 21 illustrates a honeycomb board 120 by drawing such that a surface component is broken and a honeycomb structure 120 arranged vertically is visible. Such a honeycomb structure may be made of paper or may be made of resin. The resin may include synthetic resin. Similarly, the honeycomb structure may have openings. Each of these components can be easily recycled once separated from the legs. However, these components are often in direct contact with mounted objects, so these components are unsuitable for reuse in many cases.

FIG. 23 illustrates a system for managing drum pallets as recycled pallets from a drum collection site A to a drum usage site B. At the drum collection site A, drums filled with the ones to be used or empty drums are collected. At the same time, recycled base boards and support pads are prepared, and leg support plates, leg components, and lid components for reuse and, where necessary, fastening components are prepared. Drum pallets are assembled from these components. The collected drums are mounted on the drum pallets and fixed with the fastening components. A communication terminal (for example, a smartphone, a cellular phone, or the like) disposed at a collection site are used to prepare such recycled materials and reusable materials. In other words, a signal sent from the management system is delivered to the communication terminal via a cloud. In response to this, the communication terminal provides instructions to transport recycled materials from the nearest production site or collection site to the collection site A. At the same time, the communication terminal also provides instructions to transport reusable materials from the nearest collection site to the collection site A. Then, drum pallets are assembled from the materials collected in response to the instructions, drums are mounted on the pallets, and, where necessary, the drums are fixed with fastening components. Recycled base boards and recycled support pads may be cut out from generally recycled corrugated fiberboards available near the manufacturing site. Reusable legs may include those disassembled from drum pallets that had been used at least once. The reusable legs have a shape and structure designed to improve space efficiency for easier packing and transportation resulting from disassembling. Drums loaded on such pallets are shipped with the pallets and transported by trucks and the like. At this time, information about the shipped drum-loaded pallets may be stored in the communication terminal and/or sent to the management system.

The drum-loaded pallets are transported to a port Hout to use marine transportation as needed and are stored in a typical container. The storage method and the like may be those described in the specification. The dimensions of the container may be typical ones. Therefore, a larger number of drums can be transported as compared to the number of drums transported so far. The drum-loaded pallets stored in the container are transported by a container ship. In maritime transportation, significant sway is expected due to weather conditions; however, the drum-loaded pallets are prevented by the inner walls of the container from tipping over since a method of packing the drum-loaded pallets in the container is closest packing. At this time, the environment of the drum-loaded pallets may be automatically measured and saved in the communication terminal and/or sent to the management system. Then, the drum-loaded pallets arrive in a destination port Hin. The port arrival date and time may be saved in the communication terminal and/or sent to the management system. At the port, the drum-loaded pallets are unloaded as they are and transported by trucks and the like. At this time, the drum-loaded pallets transported to near a drum usage site may be delivered by a forklift or the like to the usage site while drums still mounted on the pallets. There is a high degree of flexibility since drums are mounted in small lots three by three. At the site, drums may be used while mounted on the drum pallets or may be used after unloaded. Since the fastening components are only attached to the top edges of the drums, it is presumable that there is no harm in opening the lids of the drums. The drum pallets that are no longer needed are disassembled into reusable legs, recycled boards, and the like. The recycled base boards and support pads may be used in general recycling processes for corrugated fiberboard and the like. The reusable leg components, leg support plates, lid components, and the like, may be, for example, stored at the usage site or may be packed as needed and sent to a storage location or a planned location. Drum pallets may be assembled as recycled pallets at the above-described collection site A by using the reusable leg components and the like. This can reduce unnecessary packing materials, which can cut costs and also benefit the environment.

The assembled recycled pallet is equipped with a communication terminal (for example, a smartphone, a cellular phone, or the like) that records thereon the attributes of mounted tiles (including date of manufacture, place of manufacture, and manufacturer), specifications, destination, and the like. These pieces of information are sent to a computer of the management system from the communication terminal through a cloud or other communication means (wired or wireless electromagnetic communication means (radio waves, telegraph, and signals) or the like). The computer also communicates with tile laying sites or the like for matching with needs. For example, for materials in drums prepared based on expectations, necessary sites are grasped as needed and destinations and the like can be changed during the time from shipment to delivery. Then, at the usage site B, it is easy to grasp when the necessary materials in drums will arrive, so the usage schedule can be adjusted. A system for such adjustment may include software and may be installed on a computerized system, such as the computer of the management system. An application for this purpose may also be installed on the communication terminal.

### REFERENCE SIGNS LIST

10, 10a, 10b, 10c, 100 drum pallet
12 base board
14, 14a, 14b support pad
16 leg attachment opening
18 leg support plate
19 leg (generic name)
20 leg component
22 outer surface
24 inner surface
26 mounting surface
30 thin-walled cylindrical part
30b partial external threaded
32 partial internal thread
34 bottom opening
36 ring component
40 lid component
42 head
44 thread
46 opening
120 honeycomb structure
122 small flute
124 large flute
200 drum
220 fastening component
222, hub
224 arm
226 hook
228 adjustment component
260 hand forklift
300 container
r radius

1-16. (canceled)

17. A pallet comprising:
a base board; and
a leg configured to provide a predetermined clearance from an installation surface on a bottom surface side of the base board, wherein
the base board has a three-leaf pattern in a top view.

18. The pallet according to claim 17, wherein the base board has a collective shape of three circles of substantially equal diameters, the circles being substantially tangential to each other in a top view.

19. The pallet according to claim 17, wherein at least three of the legs are provided at rotationally symmetrical positions on the bottom surface side of the base board.

20. The pallet according to claim 17, wherein:
the base board is made of a recyclable material; and
the leg is separable from the base board and reusable.

21. The pallet according to claim 17, wherein the leg includes a combined leg component composed of an inserted leg component and a receiving leg component; and
the leg is composed of the inserted leg component and the receiving leg component that are stacked by inserting a top part of the inserted leg component to a bottom opening of the receiving leg component.

22. The pallet according to claim 18, wherein, in the collective shape of three circles, the leg is disposed at a position outside a center of any one of the circles along a line passing through the center and a center of gravity of a triangle formed by connecting the centers of the three circles.

23. A pallet system comprising:
the pallet according to claim 17; and
a fixing lid configured to secure a mounted object to be mounted on the pallet; and
a rod, wherein
the rod is configured to tighten the fixing lid and the base board.

24. The pallet system according to claim 23, wherein the rod is allowed to pass through a through-hole provided at a center of the fixing lid and a center of the base board.

25. A container storing a plurality of drums mounted on the pallet according to claim 17.

26. A transport method for drums, comprising storing a plurality of drums in a container with the pallet according to claim 17.

27. The transport method for drums according to claim 26, wherein the drums mounted on the pallet are stored in the container in a state where one of the drums is closely placed in a recess defined by other adjacent two of the drums.

28. The transport method according to claim 26, wherein the drums mounted on the pallet are loaded into a vehicle.
